(19) United States
(12) Patent Application Publication
(10) Pub. No.: US 2025/0165765 A1
(43) Pub. Date: May 22, 2025

(54) COMBINATORIAL OPTIMIZATION ACCELERATED BY PARALLEL, SPARSELY COMMUNICATING, COMPUTE-MEMORY INTEGRATED HARDWARE

(71) Applicant: Intel Corporation, Santa Clara, CA (US)

(72) Inventors: Philipp Stratmann, Bonn (DE); Alessandro Pierro, Munich (DE); Gabriel Andres Fonseca Guerra, Munich (DE); Sumedh Risbud, Berkeley, CA (US); Andreas Wild, Portland, OR (US); Ashish Rao Mangalore, Munich (DE)

(73) Assignee: Intel Corporation, Santa Clara, CA (US)

(21) Appl. No.: 18/791,687

(22) Filed: Aug. 1, 2024

Related U.S. Application Data
(60) Provisional application No. 63/639,075, filed on Apr. 26, 2024.

(51) Int. Cl. G06N 3/065; G06F 17/18

(52) U.S. Cl. CPC G06N 3/065; G06F 17/18

(57) ABSTRACT

A neuromorphic network may solve combinatorial optimization problems. The neuromorphic network may include variable neurons, a solution monitoring neuron, and one or more readout neurons. The variable neurons may each represent one binary variable in a combinatorial optimization problem. An internal state of a variable neuron may change as the variable flips. The internal state may be stored in a memory of the variable neuron. The variable neuron may spike when its internal state changes. One or more other variable neurons receiving the spike may determine whether to change their internal states based on the spike. The variable neurons may send their internal states to the solution monitoring neuron to compute a cost of the QUBO problem and determine whether a solution is found. A readout neuron may receive variable assignments resulting in the solution from at least some variable neurons and integrate the variable assignments into one message.

### CROSS-REFERENCE TO RELATED APPLICATION

This application claims the benefit of U.S. Provisional Patent Application No. 63/639,075, filed Apr. 26, 2024, and entitled “QUADRATIC UNCONSTRAINED BINARY OPTIMIZATION ACCELERATED BY NEUROMORPHIC COMPUTING HARDWARE,” which is incorporated by reference its entirety.

### TECHNICAL FIELD

This disclosure relates generally to combinatorial optimization, and more specifically, solving combinatorial optimization problems accelerated by parallel, sparsely communicating, compute-memory integrated hardware.

### BACKGROUND

Combinatorial optimization problems are optimization problems in the discrete space. Combinatorial optimization problems can have different types of solutions. Many combinatorial optimization problems are NP-hard. For instance, quadratic unconstrained binary optimization (QUBO) is a type of NP-hard combinatorial optimization problem. QUBO sometimes is also known as unconstrained binary quadratic programming. QUBO can have various applications, such as spanning logistics, robotics, machine learning, finance, telecommunications, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a combinatorial optimization system, in accordance with various embodiments.

FIG. 2 illustrates an example neuromorphic network, in accordance with various embodiments.

FIG. 3 illustrates synapses between variable neurons, in accordance with various embodiments.

FIG. 4 illustrates additional synapses for the variable neurons in FIG. 3, in accordance with various embodiments.

FIG. 5 illustrates spike integration in readout neurons 520A and 520B, in accordance with various embodiments.

FIG. 6 illustrates an example spiking neuromorphic unit, in accordance with various embodiments.

FIG. 7 is a flowchart showing a method of solving combinatorial optimization, in accordance with various embodiments.

FIG. 8 is a block diagram of an example computing device, in accordance with various embodiments.

### DETAILED DESCRIPTION

### Overview

Solvers for QUBO usually fall into two categories: complete solvers and heuristics. Complete solvers can find the global optimum of QUBO, which requires an exhaustive search of the large solution space. This typically makes them very slow or unusable for complex workloads with many variables. Heuristics can allow quickly finding a good QUBO solution. In many applications, a good solution that is found quickly is preferred over the globally optimum solution that is found through exhaustive search which may take hours, days, years, or even longer.

QUBO heuristics typically run on central processing units (CPUs), although solvers also exist for graphics processing units (GPUs), application-specific integrated circuit (ASICs), or Quantum Annealers. A range of heuristics have been developed for QUBO on CPU. CPUs can typically offer good performance for small workload sizes but usually do not offer enough parallelization to support large workload sizes with thousands or millions of variables seen in many real-world problems. CPU and GPU both feature separate compute and memory. Thus, data movement can be energy intensive and random-access memory (RAM) accesses have large latency. GPUs offer vastly more parallelism and can thus accelerate the solution to large QUBO workloads. However, they usually offer poor support for unstructured and highly sparse problems. Thus, many commercial optimization solvers do not use GPUs. In addition, GPUs are built around single instruction/multiple data (SIMD) computations, where all processors would perform the same instruction in each cycle (but on different data). However, for many QUBO solvers, computations required at different nodes in the search tree can be quite different, so SIMD computation is not well suited.

ASICs are developed to accelerate simulated annealing. They can partly parallelize simulated annealing, by checking for multiple variables xᵢ whether it may switch in each time step, and then switch one of them. However, this approach ignores the full prospects that parallelization brings to simulated annealing and fails to take advantage of the sparse variable updates and the sparse matrices present in most real-world workloads. Dedicated ASICs are furthermore single-purpose and are not capable of performing other tasks. Lastly, ASICS entail higher per-unit production costs for the single-use/smaller market.

Quantum annealers can be exotic hardware for QUBO. They can solve QUBO using quantum adiabatic annealing, a method that requires quantum mechanical effects to work. Current hardware usually can support few binary variables (such as approximately 90 maximum with a dense Q matrix), Q matrices with around 5 bit precision, but may not show quantum advantage over classical hardware.

Embodiments of the present disclosure may improve on at least some of the challenges and issues described above by leveraging neuromorphic networks to solve combinatorial optimization problems, including QUBO problems. Neuromorphic networks can facilitate a hardware-accelerated method to efficiently and quickly solve QUBO. An example neuromorphic network may be a neural network with a neuromorphic architecture. The neuromorphic network may be implemented using neuromorphic computing hardware.

In various embodiments of the present disclosure, a neuromorphic network that can be used to solve QUBO problems may include a variety of neurons, at least some of which are communicatively coupled. The neuromorphic network may be implemented by a spiking neuromorphic unit, which is a programmable processing unit that can support spiking neuromorphic architectures. The spiking neuromorphic unit may include a plurality of compute elements. A compute element may be used as at least part of a neuron in the neuromorphic network. A neuron may send a message to one or more other neurons when the neuron spikes. The message may also be referred to as a spike or a spike message. The message may include data indicating one or more internal states of the neuron. Internal states of a neuron may be stored in a memory of the neuron. The data may be used by the other neurons to compute new data, update state, perform other operations, or some combination thereof.

To map a QUBO problem to the neuromorphic network, some neurons in the neuromorphic network may be used as variable neurons. Each variable neuron may encode a variable. Each variable neuron may change its internal state(s) by modifying the value of the variable. The variable neuron may spike when or after its internal state is changed. When the variable neuron spikes, it may send a message to one or more other variable neurons. The message may indicate a change of the value of the variable in the variable neuron. Each of the other variable neurons, after receiving the message, may determine whether to update its own internal state based on the message.

The variable neurons may be communicatively coupled to a solution monitoring neuron that tracks the cost in the QUBO problem with data received from the variable neurons. The solution monitoring neuron may compute a cost and update the cost as new data (e.g., change of cost, which may be the change in the cost function of the optimization problem) is received from the variable neurons. The solution monitoring neuron may monitor whether the cost is decreasing or increasing. The solution monitoring neuron may identify the minimum cost so far and send a flag to the variable neurons for instructing the variable neurons to store the corresponding variable values as best variable assignments. After the solution monitoring neuron determines that a solution to the QUBO problem is found, the solution monitoring neuron may instruct the variable neurons to stop updating their internal states and to send out the best variable assignments.

The variable neurons may also be communicatively coupled to a noise annealing neuron that computes a noise parameter indicating a noise level in the system. The noise annealing neuron may send the noise parameter to the variable neurons that will use the noise parameter to determine whether to update their internal states. The variable neurons may also be communicatively coupled to one or more readout neurons. A readout neuron may receive the best variable assignments from a group of variable neurons and integrate the best variable assignments into a single message. The readout neuron may send the integrated message to an external device or system, such as a host processor. One or more readout neurons may also receive the minimum cost or other data from the solution monitoring neuron and provide the minimum cost or other data to the external device or system.

Different from currently available approaches, the present disclosure can leverage artificial intelligence (AI) accelerators that are programmable, compute-memory integrated. It can facilitate acceleration for sparse communicating or fine-grained parallel. The fine-grained parallelism inherent to spiking neuromorphic hardware can make it suitable to scale to large workload sizes. This can allow to solve QUBO of previously unprecedented size. For instance, this hardware can scale especially well for large workloads, such as workloads with thousands to millions of binary variables. This approach can solve QUBOs significantly faster and provide substantially more energy efficiency than many currently available approaches. Furthermore, the programmability of the hardware allows it to implement various algorithms to solve QUBO and other problems.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phase “A or B” means (A), (B), or (A and B). For the purposes of the present disclosure, the phrase “A, B, and/or C” or the phase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

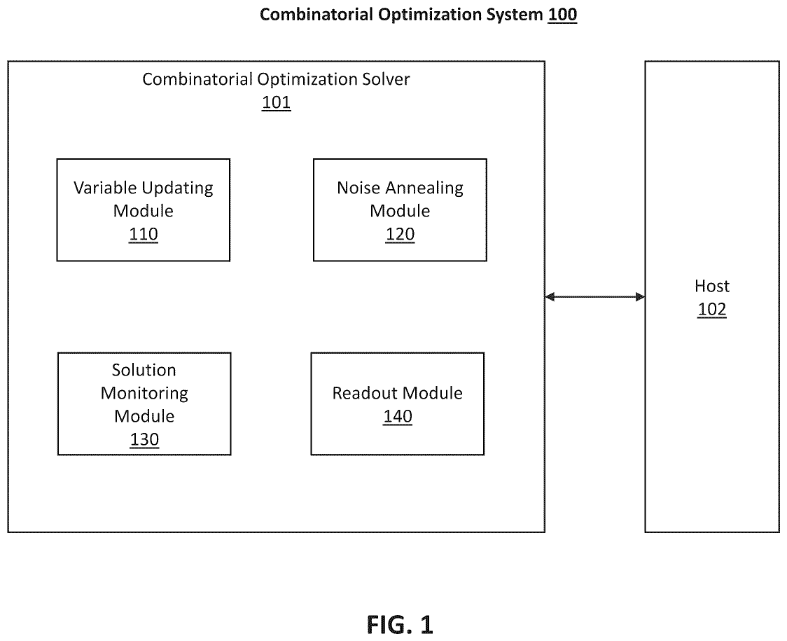

FIG. 1 is a block diagram of a combinatorial optimization system 100, in accordance with various embodiments. The combinatorial optimization system 100 includes a combinatorial optimization solver 101 and a host 102. In other embodiments, alternative configurations, different or additional components may be included in the combinatorial optimization system 100. Further, functionality attributed to a component of the combinatorial optimization system 100 may be accomplished by a different component included in the combinatorial optimization system 100 or by a different system.

The combinatorial optimization solver 101 solves combinatorial optimization problems, such as QUBO problems. To solve a QUBO problem, the combinatorial optimization solver 101 may optimize a cost function (also referred to as an energy function), which may be denoted as:

C_{Q}(x)=x^{T}Qx,

where xᵢ denotes a variable with index i and T denotes a noise parameter that indicates the noise level in the system. The combinatorial optimization solver 101 may optimize the cost function by searching for values of variables x that can minimize the cost (also referred to as an energy) C_{Q}(x). The variables may be binary variables. In some embodiments, the combinatorial optimization solver 101 may find the binary variable assignment xᵢ∈{0, 1}. The cost function may be subject to no constraints.

In some embodiments, the combinatorial optimization solver 101 may perform simulated annealing, which may start with a first guess for the best binary variable assignment. Then the combinatorial optimization solver 101 may iteratively determine whether it should flip any individual variable, e.g., by changing the value of the variable from 0 to 1 or from 1 to 0. The combinatorial optimization solver 101 may flip a variable after it determines that flipping the variable would improve the solution (e.g., the cost would decrease). Additionally or alternatively, the combinatorial optimization solver 101 may flip a variable with a specific probability when this would worsen the solution (e.g., the cost would increase). The probability for switching to worse solutions may decrease over time, indicating by the noise level or temperature T. A higher T may indicate that the likelihood of random switches is height. This way, the combinatorial optimization solver 101 may explore the overall solution space before iteratively converging towards a solution.

The combinatorial optimization solver 101 may solve a QUBO problem through an iterative process that includes a sequence of time steps. In a single time step, the combinatorial optimization solver 101 may compute T+=ΔT. For a variable xᵢ, the combinatorial optimization solver 101 may compute an cost change ΔEᵢ=updateΔEᵢ(x). The combinatorial optimization solver 101 may further determine whether e^{-AE}^{ᵢ}^{/T}=rand (0,1). When e^{-ΔE}^{ᵢ}^{/T}=rand (0,1), the combinatorial optimization solver 101 may flip the variable, otherwise the combinatorial optimization solver 101 may keep the variable as is.

The combinatorial optimization solver 101 may perform parallel processing or parallel computation. In some embodiments, the combinatorial optimization solver 101 may check for a number of variables in parallel whether they can be flipped. The combinatorial optimization solver 101 may also update a number of variables in parallel. The combinatorial optimization solver 101 may further parallelly calculate the new cost after every (parallel) variable switching. In some embodiments, the combinatorial optimization solver 101 may be restricted to use operations of low computation complexity.

As shown in FIG. 1, the combinatorial optimization solver 101 includes a variable updating module 110, a noise annealing module 120, a solution monitoring module 130, and a readout module 140. In other embodiments, the combinatorial optimization solver 101 may include fewer, more, or different components. Also, functionality attributed to a component of the combinatorial optimization solver 101 may be accomplished by a different component included in the combinatorial optimization solver 101 or by a different module.

The variable updating module 110 may update variables in a QUBO problem till the solution monitoring module 140 determines that a solution has been found. In some embodiments, the variable updating module 110 may start with random variable assignments, i.e., a random value is assigned to each variable. The initial value of each variable may be randomly chosen from a group of values, such as 0 and 1. Then the variable updating module 110 may iteratively update the values of the variables. In a single iteration, the variable updating module 110 may update one or more variables. The variable updating module 110 may not update all the variables in an iteration. In some embodiments, the variable updating module 110 may choose to not update any variable in an iteration. In some embodiments, the variable updating module 110 determines whether to update the variables independently. For instance, the variable updating module 110 may choose to update one variable but not update another variable. The variable updating module 110 may determine whether to modify the value of a variable based on an cost (or change of cost) computed using the noise level in the combinatorial optimization solver 101.

The noise annealing module 120 may track the noise level in the combinatorial optimization solver 101 during the process of solving the QUBO problem. In some embodiments, the noise annealing module 120 may compute the noise parameter T for each time step. The noise annealing module 120 may then send the noise parameter T (or a change of the noise parameter AT) to the variable updating module 110 for the variable updating module 110 to compute the cost. The noise annealing module 120 may include one or more neurons. A neuron may store the noise parameter T as an internal state and spike when the noise parameter T is updated.

The solution monitoring module 130 monitors whether a solution to the QUBO problem has been found. The solution monitoring module 130 may communicate with the variable updating module 110 and receive data from the variable updating module 110, such as variable assignments, change of cost, and so on. The solution monitoring module 130 may compute the cost using the data from the variable updating module 110 and determine if the cost is a minimum cost so far, i.e., the cost is lower than other costs computed by the solution monitoring module 130 in previous time steps. In embodiments where the solution monitoring module 130 identifies a minimum cost, the solution monitoring module 130 instructs the variable updating module 110 to store the variable assignments that leads to the minimum cost. The solution monitoring module 130 may continue to track the cost and to determine whether an even smaller cost, which would be the new minimum cost, is found. Every time the solution monitoring module 130 finds a minimum cost, it may instruct the variable updating module 110 to store the variable assignments as the best variable assignments.

The solution monitoring module 130 may determine that a solution is found after it determines that one or more criteria are met. For instance, the solution monitoring module 130 may determine that a solution is found after it determines that the minimum cost so far is not greater than a target cost. Additionally or alternatively, the solution monitoring module 130 may determine that a solution is found after it determines that the time spent on solving the QUBO problem reaches a time limit. The solution may not be the best solution (e.g., a solution that provides the least possible cost) but it may be an optimal solution that is good enough for one or more applications but does not consume too much computational resources (e.g., energy, time, etc.). After the solution monitoring module 130 determines that a solution is found, the solution monitoring module 130 may instruct the variable updating module 110 to stop updating the variables. The solution monitoring module 130 may also instruct the noise annealing module 120 to stop updating the noise parameter. The solution monitoring module 130 may further instruct the variable updating module 110 to send the best variable assignments to the host 102. The solution monitoring module 130 may send the minimum cost so far or the time used to find the solution to the host 102.

In some embodiments, the combinatorial optimization solver 101 may be a neural network, such as a neuromorphic network. Each component of the combinatorial optimization solver 101 may include one or more neurons in the neural network. At least part of the neural network may be neuromorphic computing hardware, such as a neuromorphic processing unit. In some embodiments, one or more components of the combinatorial optimization system 100 may be on a separate processing unit from one or more other components of the combinatorial optimization system 100.

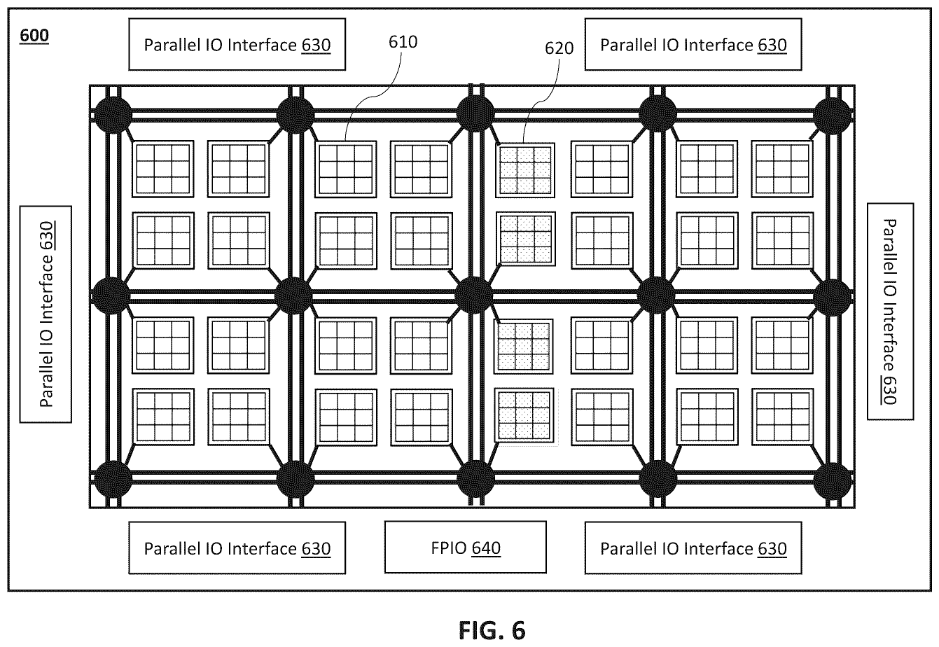

In some embodiments, the neuromorphic processing unit may include a plurality of compute elements, which may be grouped into one or more compute blocks. A compute element can perform computations, such as accumulation, subtraction, multiplication, division, other types of computations, or some combination thereof. In some embodiments, a compute element may be a neuron. In other embodiments, multiple compute elements may constitute a neuron. There may be different types of neurons, such as variable neurons, solution monitoring neurons, noise annealing neurons, and so on. A compute element may be communicatively connected to one or more other compute element, which may be in the same compute block as the compute element or in a different compute block. In some embodiments, the communicative connection, which may be referred to as a synapse, between two compute elements may be facilitated by an in-memory compute element. The compute elements in communicative connection may send data to each other, e.g., when the compute elements spike. The communication between two compute elements may be bidirectional so that they can pass spikes to each other in both forward spike propagation and backward spike propagation. Certain aspects of spiking neuromorphic units are described below in conjunction with FIG. 6.

The host 102 receives solutions of combinatorial optimization problems from the combinatorial optimization solver 101. The host 102 may use the solutions of combinatorial optimization problems to perform various tasks, such as tasks in applications including spanning logistics, robotics, machine learning, finance, telecommunications, and so on. In some embodiments, the host 102 may also provide solutions of combinatorial optimization problems accessible to users. For instance, the host 102 may facilitate users to view, download, edit, or comment on best variable assignments, minimum costs, time consumed for finding solutions, or other types of data from the combinatorial optimization solver 101. In some embodiments, the host 102 may monitor, control, or manage operations of the combinatorial optimization solver 101. For example, the host 102 may facilitate a training process, through which weights corresponding to synapses in the neural network are determined. As another example, the host 102 may provide configuration descriptors that can be used by components in the combinatorial optimization solver 101 for solving combinatorial optimization problems.

In some embodiments, the host 102 may include one or more processing units, such as CPUs. The combinatorial optimization solver 101 and the host 102 may include separate processing units. In an example, the combinatorial optimization solver 101 may include a spiking neuromorphic unit while the host 102 may include a CPU. The two processing units may be arranged in the same chip or different chips.

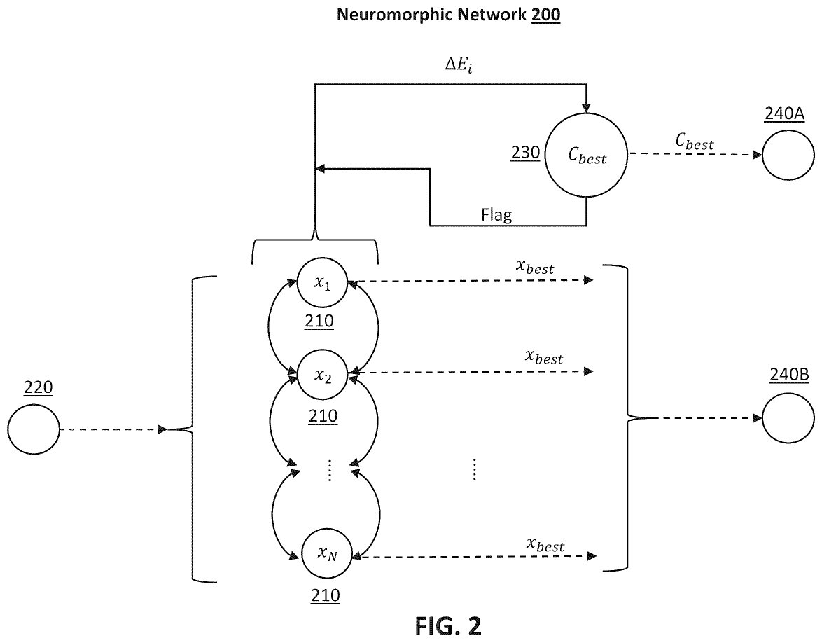

FIG. 2 illustrates an example neuromorphic network 200, in accordance with various embodiments. The neuromorphic network 200 can solve combinatorial optimization problems. The neuromorphic network 200 may be an embodiment of the combinatorial optimization solver 101 in FIG. 1. As shown in FIG. 2, the neuromorphic network 200 includes a plurality of variable neurons 210 (individually referred to as “variable neuron 210”), a noise annealing neuron 220, a solution monitoring neuron 230, and two readout neurons 240A and 240B. In other embodiments, the neuromorphic network 200 may include fewer, more, or different neurons. For instance, the neuromorphic network 200 may include more than one noise annealing neuron or more than one solution monitoring neuron. The neuromorphic network 200 may include one or more than two readout neurons. The arrangement of the neurons in the neuromorphic network 200 may also be different.

The variable neurons 210, noise annealing neuron 220, solution monitoring neuron 230, and readout neurons 240A and 240B are collectively referred to as neurons. In some embodiments, a neuron may be a processing element that can perform computations, such as subtraction, accumulation, multiplication, other types of computations, or some combination thereof. A processing element may integrate compute and memory functions. For instance, a processing element may include or be otherwise associated with a memory that stores data received, processed, or computed by the processing element. In some embodiments, each processing element may have its own memory, such as an internal memory. In other embodiments, a group of processing element may share a single memory. The memory (or memories) and the processing elements may be implemented on the same chip.

Neurons in the neuromorphic network 200 are communicatively coupled. A neuron may send data to one or more other neurons that the neuron is communicatively coupled to. Neurons may be communicatively coupled to each other through a connection between the neurons. The connection may be a synapse. A neuron may send out data, such as data computed by the neuron, when it spikes. Spikes may propagate to all the neurons that are communicatively coupled to the neuron. In some embodiments, a spike of information may propagate through multiple paths in neuromorphic network 200. The information in the spike may include one or more values indicating one or more internal states of the neuron. In some embodiments, a neuron receiving the information may use the information to update its own internal state. Communications between neurons may be bidirectional.

In some embodiments, the neuromorphic network 200 includes a plurality of layers. A layer may include one or more of the neurons in the neuromorphic network 200. For instance, the noise annealing neuron 220 may be in the first layer of the neuromorphic network 200, the variable neurons 210 may be in the second layer, the solution monitoring neuron 230 may be in the third layer, and the two readout neurons 240A and 240B may be in the fourth layer. Some or all the four layers may be arranged in a sequence. Neurons in different layers may be communicatively coupled. The communications between neurons from different layers may be bidirectional.

The variable neurons 210 may represent variables in QUBO problems. For the purpose of illustration, FIG. 2 shows that variable neurons 210 that represent N variables x₁ through x_{N} in a QUBO problem. In some embodiments, each variable xᵢ is represented by one variable neuron 210. i denotes the index of the variable and may also denote the index of the variable neuron 210. The variable xᵢ may be a binary variable, the value of which is either 0 or 1. The variable neuron 210 may have one or more internal states, such as the value of the variable xᵢ, an cost parameter ΔEᵢ that indicates the change in cost when the variable xᵢ is flipped, a noise parameter T that indicates the measure of the current noise level, a flipping parameter e^{-ΔE}^{ᵢ}^{/T}, a pseudo parameter lfsr that is a (pseudo) random number that is changed in each time step, and a best state value x_{i,best} that indicates the variable assignment that leads to the minimal cost C_{Q}(x) so far.

In some embodiments, the variable neurons 210 may carry out an iterative process to find the best variable assignments for the QUBO problem. The variable neurons 210 can preserve their internal states (e.g., intrinsic memory states) across time steps, which may be facilitated by the compute-memory integration described above. In the first iteration, the variable neuron 210 representing a variable xᵢ may be assigned with an initial value of the variable xᵢ and then update the value of the variable xᵢ iteratively. In an example, the initial value of the variable xᵢ may be randomly chosen. The variable neuron 210 may compute other internal states from xᵢ. In each of the subsequent time steps, the variable neuron 210 may determine whether to flip the variable xᵢ. For instance, the variable neuron 210 may compare the flipping parameter with a random number. The random number may be randomly chosen from 0 and 1. In response to determining that the flipping parameter is greater than the random number, the variable neuron 210 may flip the variable xᵢ. In response to determining that the flipping parameter is not greater than the random number, the variable neuron 210 may keep the variable xᵢ the same.

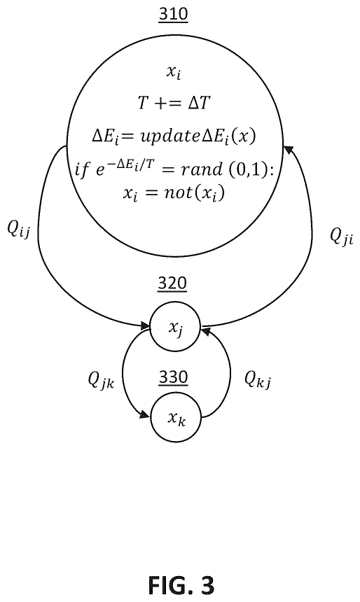

In an example iteration in which the variable neuron 210 flips the variable xᵢ (e.g., the variable neuron 210 changes the value of the variable xᵢ from 0 to 1 or from 1 to 0), the variable neuron 210 may spike and send a spike message to one or more other variable neurons 210 (“downstream variable neurons”) that are communicatively coupled to the variable neuron 210. In some embodiments, the variable neuron 210 may send out the spike message through synapses by which the variable neuron 210 is communicatively coupled to the downstream variable neurons. The spike message may indicate a modification of the value of the variable xᵢ, which may be denoted as Δxᵢ. Each downstream variable neuron, after receiving the spike message, may determine whether to flip its own variable xⱼ based on the spike message. Certain aspects regarding internal states and spikes of variable neurons are described below in conjunction with FIG. 3.

The variable neurons 210 may also keep track of the best variable assignment found so far. A variable neuron 210 may store the current value of the variable xᵢ as a new best state value x_{i,best} in one or more iterations. In some embodiments, the variable neuron 210 may store the current value of the variable xᵢ as a new best state value x_{i,best} in response to receiving a message from the solution monitoring neuron 230. The message may include a flag indicating that a cost computed by the solution monitoring neuron 230 based on the current value of the variable xᵢ is the minimum cost so far. In a specific embodiment, it can store several states x_{i,best}, which may provide solutions of same or different cost. In one or more subsequent time steps, the variable neuron 210 may update the best state value x_{i,best}. For instance, the variable neuron 210 may store a different value of the variable xᵢ as a new best state value x_{i,best} in response to receiving a message from the solution monitoring neuron 230 indicating that the different value of the variable xᵢ leads to the minimum cost so far. After the iterative process is complete, the variable neurons 210 may send their best variable assignments to the readout neurons 240B.

The noise annealing neuron 220 tracks the level of noise in the neuromorphic network 200. In some embodiments, the noise annealing neuron 220 determines a noise parameter T that indicates the measure of the current noise level, i.e., the noise level in the current time step. The noise annealing neuron 220 may update the noise parameter T in every time step of the iterative process. The noise annealing neuron 220 may send the noise parameter T to the variable neurons 210. For instance, the noise annealing neuron 220 may spike every time it updates the noise parameter T and send a spike indicating the value of the noise parameter T or the change of the value of the noise parameter T (e.g., ΔT) to all the variable neurons 210. The value of the noise parameter T may decrease over time. In some embodiments, the value of the noise parameter T may decrease linearly over the time steps. In other embodiments, the value of the noise parameter T may decrease geometrically over the time steps. In some embodiments, the neuromorphic network 200 may include no noise annealing neuron and the variable neurons 210 may compute the noise parameter T separately or independently, which may consume more computational resources than using a single neuron (i.e., the noise annealing neuron 220) to compute the noise parameter T for the system.

The solution monitoring neuron 230 tracks the cost of variable assignments. The solution monitoring neuron 230 may have an internal state (e.g., an internal memory state) that represents the cost C_{Q}(x). The initial internal state of the solution monitoring neuron 230 may be denoted as C_{Q}(x)=x^{T}Qx=Σ_{i,j}xᵢQ_{i,j}xⱼ, where Q_{i,j} denotes the weight corresponding to the connection between a variable neuron 210 representing variable xᵢ and another variable neuron 210 representing variable xⱼ. The solution monitoring neuron 230 may update its internal state as it receives data indicating updates of the internal states of the variable neurons 210. In an example, the solution monitoring neuron 230 may receive ΔEᵢ from each variable neuron 210 that has flipped its variable xᵢ. The solution monitoring neuron 230 may compute the cost of the variable assignment according to C_{Q}(x)+=ΣᵢΔEᵢ.

In some embodiments, the solution monitoring neuron 230 may act as a state machine. The solution monitoring neuron 230 may determine whether the cost of the current variable assignment is better (i.e., smaller) than that of any previous variable assignments. In response to a determination that the current cost is better, the solution monitoring neuron 230 may update its internal state with the current cost. The solution monitoring neuron 230 may also spike and send a flag to the variable neurons 210. The flag may indicate that a better cost was found. The flag may instruct the variable neurons 210 to store the current values of the variables as the best assignment.

In some embodiments, the solution monitoring neuron 230 may generate different types of flags to be sent to the variable neurons 210. Examples of the flags may include a flag instructing the variable neurons 210 to store the best variable assignments, a flag instructing the variable neurons 210 to spike the best variable assignments, a flag instructing the variable neurons 210 to store and spike the best variable assignments, and so on. In an embodiment, the flags may be encoded by different numbers, such as 1, 2, and 3. For instance, 1 may be the flag instructing the variable neurons 210 to store the best variable assignments, 2 may be the flag instructing the variable neurons 210 to spike the best variable assignments, and 3 may be the flag instructing the variable neurons 210 to store and spike the best variable assignments. The variable neurons 210 may operate in accordance with the flags. In some embodiments, the variable neurons 210 may efficiently determine what they should do by determining whether the flag is larger or smaller than a specific threshold. For instance, the variable neurons 210 would store the best variable assignments in response to a determination that the flag is not greater than 2. The variable neurons 210 would spike the best variable assignments in response to a determination that the flag is not smaller than 2.

In some embodiments, the solution monitoring neuron 230 may also determine whether the process of solving the QUBO problem can be ended. For instance, the solution monitoring neuron 230 may determine whether one or more criteria for ending the process are met. An example criterion is that the cost reaches a cost threshold, e.g., the cost is not greater than the cost threshold. Another example criterion is that the amount of time spent on solving the QUBO problem reaches a time limit. The time limit may be a user-provided time out limit. In response to determining that one or more criteria for ending the process are met, the solution monitoring neuron 230 may send a flag to all the variable neurons 210 and instruct them to spike their current best variable assignments x_{i,best} to the readout neuron 240B. The solution monitoring neuron 230 may send the best cost C_{best} (e.g., the smallest cost C_{Q}(x)) and the time to solution to the readout neuron 240A.

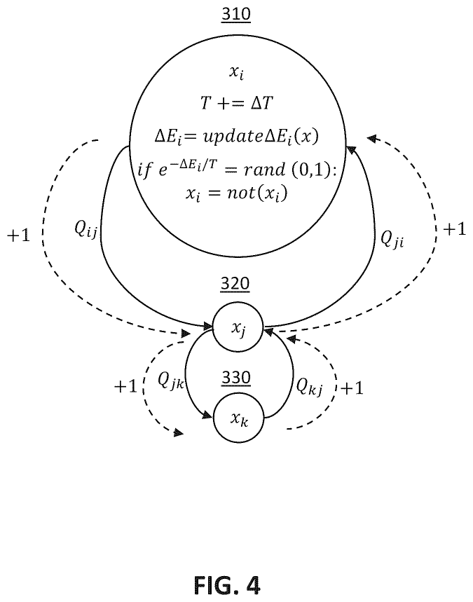

The two readout neurons 240A and 240B send solutions of QUBO problems out from the neuromorphic network 200. In the embodiments of FIG. 2, the readout neuron 240A is communicatively coupled to the solution monitoring neuron 230, and the readout neuron 240B is communicatively coupled to the variable neurons 210. The readout neuron 240A may receive spikes from the solution monitoring neuron 230, such as spikes indicating the minimum cost found by the neuromorphic network 200, spikes indicating the time to solution, and so on. The readout neuron 240B may receive the best variable assignments x_{i,best} from the variable neurons 210. The readout neuron 240A or 240B may forward the data to an external device or system, such as the host 102, for making the data accessible by the external device or system or a user. Certain aspects of readout neurons are provided below in conjunction with FIG. 4.

FIG. 3 illustrates synapses between variable neurons, in accordance with various embodiments. For the purpose of illustration and simplicity, FIG. 3 shows three variable neurons 310, 320, and 330. The variable neurons 310, 320, and 330 may be in a neuromorphic network, such as the neuromorphic network 200. The variable neurons 310, 320, and 330 represent three variables xᵢ, xⱼ, and xₖ, respectively. The variable neurons 310, 320, and 330 are communicatively coupled, which are shown by the arrows in FIG. 3. For the purpose of illustration and simplicity, FIG. 3 shows the communication connection between the variable neuron 310 and the variable neuron 320 as well as the communication connection between the variable neuron 320 and the variable neuron 330. Even though not shown in FIG. 3, the variable neuron 310 may be communicatively coupled to the variable neuron 330. Also, the variable neuron 310, 320, or 330 may be communicatively coupled to one or more other variable neurons not shown in FIG. 3.

As shown in FIG. 3, the variable neuron 310 has a number of internal memory states: xᵢ, T, ΔEᵢ, and e^{-ΔE}^{ᵢ}^{/T}. Even though not shown in FIG. 3, the variable neuron 310 may have other internal memory states, such as lfsr, x_{i,best}, and so on. The variable neuron 320 or 330 may have the same types of internal memory states as the variable neuron 310. As the variable neuron 310, 320, or 330 updates its internal state, the variable neuron 310, 320, or 330 may spike and send data to connected variable neuron(s), and the latter may update its internal state based on the received data. For the purpose of illustration, some of the descriptions below are focused on the variable neuron 310 and the variable neuron 320, which constitute a pair of variable neurons (i,j).

In an embodiment, the variable neuron 310 may set the initial value of the variable xᵢ to a random number. The random number may be 0 or 1. The variable neuron 310 may compute the internal state ΔEᵢ(xᵢ=0→1), such as the initial ΔEᵢ, using the following function:

$$Δ {E}_{i} ( {x}_{i} = 0 \to 1 ) = {Q}_{i , i} + {\sum }_{j \neq i} {x}_{j} {Q}_{j , i} + {\sum }_{j \neq n} {Q}_{i , j} {x}_{j} ,$$

where Q_{i,j} denotes the weight corresponding to the connection (e.g., a synapse) from the variable neuron 310 to the variable neuron 320, Q_{j,i} denotes the weight corresponding to the connection from the variable neuron 320 to the variable neuron 310, and Q_{i,i} denotes an internal weight of the variable neuron 310. In some embodiments, the weights corresponding to the connection between the variable neuron 310 and the variable neuron 320 may be symmetric, meaning Q_{i,j}=Q_{j,i}. The neuromorphic network may have a weight tensor, and the weights corresponding to the connections between the variable neurons are elements of the weight tensor. The position of each weight in the weight tensor may depend on the indexes of the corresponding variable neurons. The value of the weights may be determined by training the neuromorphic network. The value of x₁ may be 0 or 1.

In each subsequent time step, the variable neuron 310 may determine whether to flip based on the internal state e^{-ΔE}^{ᵢ}^{/T}. The variable neuron 310 may compute e^{-ΔE}^{ᵢ}^{/T} from the internal state ΔEᵢ and the internal state T. In some embodiments, the variable neuron 310 may flip xᵢ when it determines that e^{-ΔE}^{ᵢ}^{/T}>rand(0, 1), where rand(0, 1) denotes a function that randomly selects a number from 0 and 1. The variable neuron 310 may keep xᵢ as is when it determines that e^{-ΔE}^{ᵢ}^{/T}<rand(0, 1). In other embodiments, the variable neuron 310 may determine whether ΔEⱼ is greater than

$$- T \cdot [ {log}_{2} ( \frac{lfsr}{{r}_{max}} ) ] .$$

The variable neuron 310 may flip xᵢ when ΔEⱼ is not greater than

$$- T \cdot [ {log}_{2} ( \frac{lfsr}{{r}_{max}} ) ] ,$$

where rₘₐₓ denotes the maximum value in a plurality of random numbers. This may be beneficial for neuromorphic computing hardware (e.g., a spiking neuromorphic unit) that has an integer-valued random number generator that can generate random numbers in the range (0, . . . , rₘₐₓ). The random number generator may be a linear-feedback shift register (LFSR). In an embodiment, rₘₐₓ may be a power of 2 and may be denoted as rₘₐₓ=2^{p}, so that

$$Δ E \leq - T \cdot [ {log}_{2} ( \frac{lfsr}{{r}_{max}} ) ]$$

may be simplified to ΔE<T·[p−log₂(lfsr)].

In an example for n>0, clz n=q−1−└log₂(n)┘, where clz stands for count leading zeros and is an operation that counts the leading zeros of the integer number n of q bit precision. This way, the variable neuron 310 may determine whether to flip by performing computationally efficient operations, which may be denoted as:

$$flip if \{ \begin{matrix}Δ E < T \cdot [ clz ( lfsr ) + p - q + 1 ] if lfsr > 0 \\ always if lfsr == 0\end{matrix} if lfsr > 0.$$

In embodiments where the variable neuron 310 flips in subsequent time steps, the overall cost C_{Q}(x) of the full variable assignment x would change by:

$$Δ {E}_{i} = Δ {E}_{i} ( {x}_{i} = 0 \to 1 ) \cdot \{ \begin{matrix}( + 1 ) & if {x}_{i} == 0 \\ ( - 1 ) & if {x}_{i} == 1\end{matrix} .$$

After the variable neuron 310 determines to flip, the variable neuron 310 may change the value of xᵢ from 0 to 1 (i.e., xᵢ=0→1) or from one to zero (i.e., xᵢ=1→0). When or after the variable neuron 310 flips xᵢ in a subsequent time step, the variable neuron 310 may spike and send a spike message to the variable neuron 320. The spike message may indicate the change of the value of xᵢ, i.e., Δxᵢ. Δxᵢ=+1 when xᵢ=0→1, versus Δxᵢ==1 when xᵢ=1→0. After receiving the spike message, the variable neuron 320 may update its internal state ΔEⱼ. The variable neuron 320 may compute ΔEⱼ from Δxᵢ and Q_{i,j}. For instance, the variable neuron 320 may compute ΔEⱼ according to ΔEⱼ+=2·E_{j≠i}ΔxᵢQ_{i,j}. This way, the variable neuron 320 can compute ΔEⱼ using spike message and access to locally stored information, which can make the computation efficient. The variable neuron 320 may use ΔEⱼ to determine whether to flip. In some embodiments, the variable neuron 320 may determine whether to flip using the same methods as the variable neuron 310, such as the methods described above.

The variable neuron 320 and the variable neuron 330 may constitute another pair of neurons (j,k). Similarly, the variable neuron 310 and the variable neuron 330 may constitute another pair of neurons (i,k). When or after the variable neuron 320 flips xⱼ, the variable neuron 320 may spike and send a spike message, which may include Δxⱼ, to the variable neuron 330. The variable neuron 330 may compute ΔEₖ from Δxⱼ and Q_{j,k}. The variable neuron 320 may also send the spike message to the variable neuron 310, and the variable neuron 310 may determine whether to flip again based on the spike message from the variable neuron 320. In embodiments where the variable neuron 330 is communicatively coupled to the variable neuron 310, the variable neuron 330 may also receive the spike message from the variable neuron 310 and determine whether to flip based on the spike message from the variable neuron 310. There may be one or more other pairs of neurons in the neuromorphic network.

In some embodiments, the variable neurons 310, 320, and 330 (or more variable neurons) may set up their initial states in parallel. For instance, these variable neurons may set up their initial states in the same time step. The variable neurons 310, 320, and 330 (or more variable neurons) may determine whether to modify their states in parallel in subsequent time steps. For instance, each of the variable neurons may determine, in the same subsequent time step, whether to flip its state based on one or more messages from one or more other variable neurons.

When two neurons (i,j) have a non-zero weight (i.e., Q_{i,j}≠0) and flip their variables simultaneously, the non-zero interaction term may substantially worsen the solution as the cost C=ΣᵢΣⱼxᵢQ_{i,j} x can increase substantially. Taking a QUBO workload with a weight tensor

$$Q = [ \begin{matrix}- 1 & + 3 & 0 \\ + 3 & - 2 & + 2 \\ 0 & + 2 & + 5\end{matrix} ]$$

for example, the weight tensor includes 9 weights corresponding to three variable neurons representing three variables x₁, x₂, and x₃. The neurons representing variables x₁ and x₂ have a non-zero interaction term Q_{1,2}=Q_{2,1}=+3. Even when they individually decide that it is good to flip, flipping both variables simultaneously can substantially worsen the solution. For instance, when x₁ and x₂ are both flipped from 0 to 1, E=−1−2+3+3=3. In contrast, when x₁=0 and x₂=1, E=−2; when x₁=1 and x₂=0, E=−1; when x₁ and x₂ are both 0, E=0. This problem may be avoided by having an additional synapse between the two neurons.

FIG. 4 illustrates additional synapses for the variable neurons 310, 320, and 330 in FIG. 3, in accordance with various embodiments. The additional synapses are shown by the dashed arrows in FIG. 4, while the original synapses are shown by the solid arrows in FIG. 4. In some embodiments, all pairs of neurons (i,j) that have a synapse of weight Q_{i,j}≠0 may have an additional synapse of weight +1, as shown in FIG. 4. These synapses are there to communicate whether two conflicting variables are to flip simultaneously. When two neurons simultaneously decide to flip, they may communicate a signal to the connected neurons to communicate which of the conflicting neurons may flip. In some embodiments, the neurons communicate a signal of +1. The connecting neurons may then add up the total number of conflicting neurons as input and when it suggested to switch, may switch with a probability

$$p = \frac{1}{\# conflicting neurons + 1} ,$$

where # conflicting neurons denotes the total number of conflicting neurons. In other embodiments, all neurons that suggest flipping will send a random number via the additional synapses. When they receive any larger or smaller random number, they would not switch their internal states and thus leave the switching to a conflicting neuron. This way, this can avoid the conflicting neurons from flipping in the same time step.

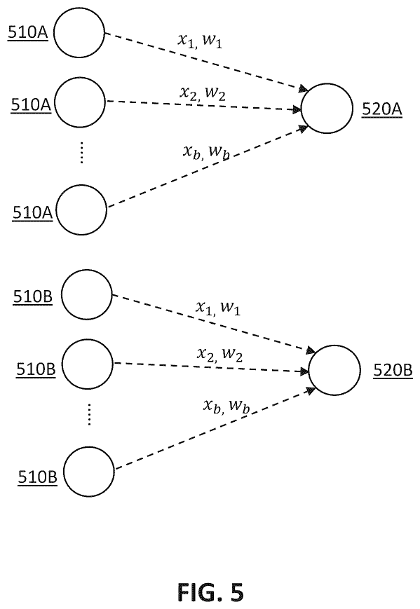

FIG. 5 illustrates spike integration in readout neurons 520A and 520B, in accordance with various embodiments. The readout neuron 520A is communicatively coupled to a group of variable neurons 510A (individually referred to as “variable neuron 510A”). The variable neurons 510A may send their best variable assignments to the readout neuron 520A. The readout neuron 520B is communicatively coupled to a group of variable neurons 510B (individually referred to as “variable neuron 510B”). The variable neurons 510B may send their best variable assignments to the readout neuron 520B. The variable neurons 510A and 510B and the readout neurons 520A and 520B may be inside a neuromorphic network, an example of which is the neuromorphic network 200. The neuromorphic network may include neurons that are not shown in FIG. 5, such as more readout neurons, more variable neurons, solution monitoring neuron, and so on. Also, the neuromorphic network may include less neurons, such as less readout neurons or less variable neurons than the embodiments of FIG. 5.

In some embodiments, each of the readout neurons 520A and 520B may be coupled to a fixed number of variable neurons. Each readout neuron may include a spike integrator that can integrate spike messages received from the corresponding variable neurons to generate a single message. The single message may include the values of the binary variables determined by the variable neurons as a solution to the QUBO problem. In some embodiments, the neuromorphic network is implemented by neuromorphic computing hardware, which may communicate in integer spike messages with b-bit precision for efficient communication. The total number of variable neurons 510A coupled with the readout neuron 520A and the total number of variable neurons 510B coupled with the readout neuron 520B may both be b. The readout neurons 520A and 520B may bundle the binary variable assignments x_{i,best} into b-bit spike messages for more efficient communication. For instance, the readout neuron 520A or 520B may generate a b-bit message from the binary variables x_{i,best} received from the variable neurons 510A or 510B.

The first variable neuron may be routed via a synapse of weight w₁=0b1<<(b−1), where << denotes binary left shift, for sending a binary variable x₁ to the corresponding readout neuron. The second variable neuron may send its binary variable x₂ via a synapse of weight w₂=0b1<<(b−2). Similarly, w₃=0b1 (b−3) for x₃, w₄=0b1<<(b−4) for x₃ . . . w_{b-2}=0b100 for x_{b-2}, w_{b-1}=0b10 for x_{b-1}, and w_{b}=0b1 for x_{b}. The b-bit message generated by the readout neuron may be denoted as 0bx₁x₂x₃ . . . , where each binary variable occupies one bit of the b-bit spike message. The readout neuron may further send the b-bit message to an external device or system, e.g., a host. In some embodiments, the synapses may have a limited precision (e.g., 8 bits, 16 bits, etc.) and a common weight exponent that can scale the synaptic weights by a power of 2, which may be equivalent to a binary left shift. For instance, a weight of w₉=0b=100000000 would be equivalent to a weight of w₉=0b1<<8. Accordingly, this neuromorphic network can efficiently transfer the binary variable assignments that solve the QUBO problem from the variable neurons to a host for further processing.

FIG. 6 illustrates an example spiking neuromorphic unit 600, in accordance with various embodiments. The spiking neuromorphic unit 600 may be hardware that can implement at least part of the combinatorial optimization system 100. As shown in FIG. 6, the spiking neuromorphic unit 600 includes compute units 610 (individually referred to as “compute unit 610”), compute units 620 (individually referred to as “compute unit 620”), parallel input/output (IO) interfaces 630 (individually referred to as “parallel 10 interface 630”), and a tour pin input/output (FPIO) interface 640. In other embodiments, alternative configurations, different or additional components may be included in the spiking neuromorphic unit 600. For example, the spiking neuromorphic unit 600 may include a different number of compute unit, parallel 10 interface, or FPIO interface. As another example, the layout of the compute units 610 and 620 may be different. Further, functionality attributed to a component of the spiking neuromorphic unit 600 may be accomplished by a different component included in the spiking neuromorphic unit 600 or by a compute block.

The compute units 610 can train or deploy spiking neural networks, such as neuromorphic networks. A compute unit 610 may be referred to as a neural core. A neural core may include a plurality of neurons that may be integrated together. A neuron may be a compute element that can perform computations. For the purpose of illustration, a compute unit 610 includes nine neurons in FIG. 6. In other embodiments, a compute unit 610 may include a different number of neurons. For instance, the number of neurons in a compute unit 610 may be in a range from 100 to 1000. A compute unit 610 may be associated with a limited internal memory that can be accessed by the neurons during execution. The compute units 610 may be neuromorphic computing hardware. For instance, the compute units 610 may implement at least part of a neuromorphic network, such as the neuromorphic network 200 in FIG. 2.

The neurons can communicate with each other asynchronously using binary (single-bit) or graded (multiple-bit) spikes or messages. In some embodiments, some or all the compute units 610 may be devoid of a clock. The notion of a time step may be maintained by a synchronization process that is a handshaking mechanism between the compute units 610 that is run when the spikes generated for each compute unit 610 are sent out. This can flush out all the remaining spiking activity and prepares the compute units 610 for the next algorithmic time step. Message passing can be done by using physical interconnects between the compute unit 610 or between neurons. The physical interconnects are represented by the dark lines and black circles in FIG. 6.

A compute unit 620 may be a CPU or part of a CPU (e.g., compact Von Neumann CPUs). The compute units 620 may execute special functions not tenable on the compute units 610, e.g., some or all functions of the host 102. In some embodiments, the compute units 620 are implemented on the same chip(s) as the compute units 610. In other embodiments, the compute units 620 are implemented on separate chips from the compute units 610.

The chip(s) can be scaled to increase the number of compute units 610 or 620, e.g., to accommodate large graphs. The chip-to-chip communication may be facilitated using the parallel 10 interfaces 630 or the FPIO interface 640. The parallel 10 interfaces 630 or the FPIO interface 640 can also offer support for Ethernet-based communication or other types of communications, such as slow serial communication.

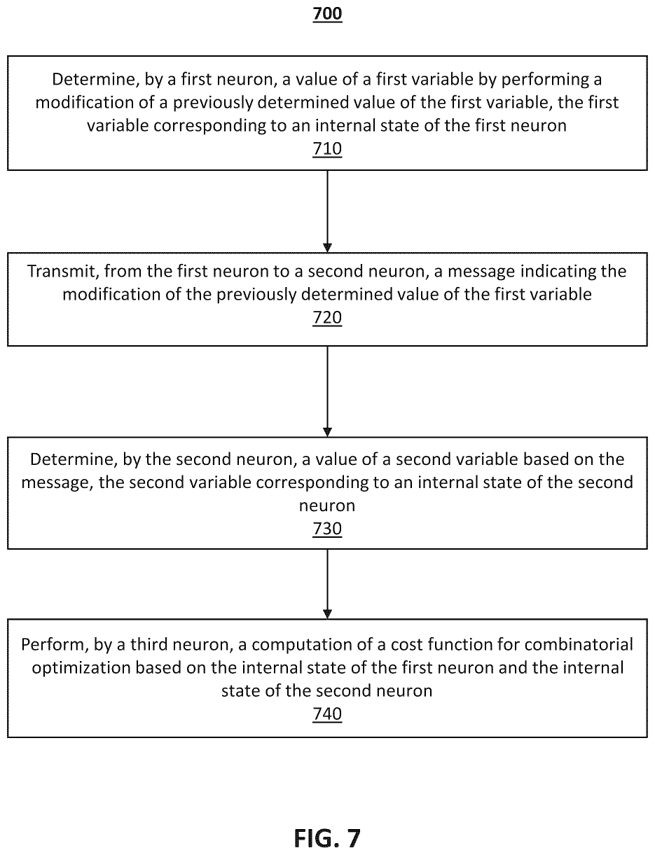

FIG. 7 is a flowchart showing a method 700 of solving combinatorial optimization, in accordance with various embodiments. The method 700 may be performed by the neuromorphic network 200 in FIG. 2. Although the method 700 is described with reference to the flowchart illustrated in FIG. 7, many other methods for solving combinatorial optimization may alternatively be used. For example, the order of execution of the steps in FIG. 7 may be changed. As another example, some of the steps may be changed, eliminated, or combined.

The neuromorphic network 200 determines 710, by a first neuron in the neuromorphic network 200, a value of a first variable by performing a modification of a previously determined value of the first variable. The first variable corresponds to an internal state of the first neuron.

The neuromorphic network 200 transmits 720, from the first neuron to a second neuron in the neuromorphic network 200, a message indicating the modification of the previously determined value of the first variable. In some embodiment, the neuromorphic network 200 transmits the message from the first neuron to the second neuron through a synapse between the first neuron and the second neuron.

The neuromorphic network 200 determines 730, by the second neuron, a value of a second variable based on the message. The second variable corresponds to an internal state of the first neuron. In some embodiments, the neuromorphic network 200 computes a change of cost based on the modification of the value of the first variable by the first neuron. The neuromorphic network 200 determines whether to modify a previously determined value of the second variable based on the change of cost. In some embodiments, the neuromorphic network 200 determines whether to modify a previously determined value of the second variable further based on a weight. The weight corresponds to a synapse through which the message from the first neuron is sent to the second neuron.

In some embodiments, the neuromorphic network 200 determines whether to modify a previously determined value of the second variable further by computing a probability of modifying its state based on the message from the first neuron. In some embodiments, the neuromorphic network 200 determines whether to modify a previously determined value of the second variable further by comparing a number in the message from the first neuron with one or more other numbers.

In some embodiments, the neuromorphic network 200 transmits the message from the first neuron to a fourth neuron. The neuromorphic network 200 determines, by the fourth neuron based on the message, a value of another variable stored in a memory of the fourth neuron. In some embodiments, the neuromorphic network 200 determines the value of the other variable further based on a weight corresponding to a synapse through which the message from the first neuron is sent to the fourth neuron.

The neuromorphic network 200 performs 740, by a third neuron in the neuromorphic network 200, a computation of an cost function for combinatorial optimization based on the internal state of the first neuron and the internal state of the second neuron. In some embodiments, after the computation of the cost function, the neuromorphic network 200 transmits a message from the third neuron to the first neuron or the second neuron. The message from the third neuron causes the first neuron or the second neuron to store the value of the first variable or the second variable as a best value of the first variable or the second variable.

In some embodiments, the neuromorphic network 200 determines, by the third neuron, whether the cost reaches a target cost. In response to determining the cost reaches a target cost, the neuromorphic network 200 transmits from the third neuron the message to the first neuron or the second neuron. In some embodiments, the neuromorphic network 200 determines, by the third neuron, whether a time spent on the combinatorial optimization reaches a time limit. In response to determining the time spent on the combinatorial optimization reaches the time limit, the neuromorphic network 200 transmits from the third neuron the message to the first neuron or the second neuron.

In some embodiments, the neuromorphic network 200 determines, by a fourth neuron in the neuromorphic network 200, a level of noise. The fourth neuron is communicatively coupled with the first neuron and the second neuron. The neuromorphic network 200 sends, by the fourth neuron, a message to the first neuron or the second neuron for reducing the level of noise.

In some embodiments, the neuromorphic network 200 transmits, by the first neuron, a best value of the first variable to a fourth neuron in the neuromorphic network 200. The best value of the first variable corresponds to a minimum cost computed by the third neuron. The neuromorphic network 200 transmits, by the second neuron, a best value of the second variable to the fourth neuron. The best value of the second variable corresponds to the minimum cost computed by the third neuron. The neuromorphic network 200 integrates, by the fourth neuron, the best value of the first variable and the best value of the second variable and generates a single message. The neuromorphic network 200 sends, by the fourth neuron, the single message to a host processor.

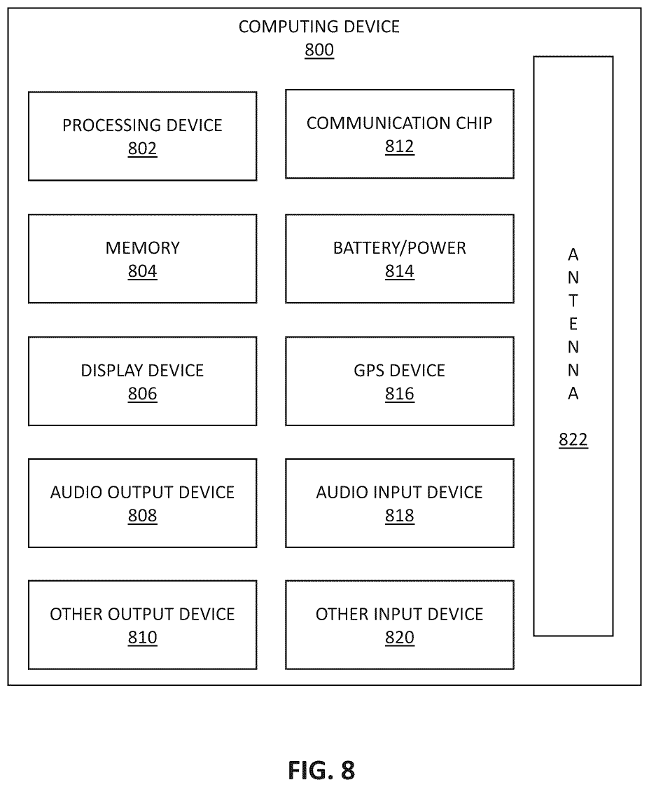

FIG. 8 is a block diagram of an example computing device 800, in accordance with various embodiments. In some embodiments, the computing device 800 may be used for at least part of the combinatorial optimization system 100 in FIG. 1. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include an audio input device 818 or an audio output device 808, but may include audio input or output device interface circuitry (e.g., connectors and supporting circuitry) to which an audio input device 818 or audio output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 804 may include memory that shares a die with the processing device 802. In some embodiments, the memory 804 includes one or more non-transitory computer-readable media storing instructions executable for solving combinatorial optimization problems, e.g., the method 700 described above in conjunction with FIG. 7 or some operations performed by the combinatorial optimization system 100 in FIG. 1. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include an audio codec, a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### Select Examples

The following paragraphs provide various examples of the embodiments disclosed herein.

Example 1 provides an apparatus, including a first neuron of a neural network, the first neuron comprising a first memory for storing a first variable, different values of the first variable corresponding to different states of the first neuron; a second neuron of the neural network, the second neuron communicatively coupled to the first neuron and comprising a second memory for storing a second variable, different values of the second variable corresponding to different states of the second neuron, the second neuron to determine whether to modify its state based on a message from the first neuron; and a third neuron of the neural network, the third neuron communicatively coupled to the first neuron and the second neuron for computing a cost, using a cost function, from data received from the first neuron and data received from the second neuron and comprising a third memory for storing the cost.

Example 2 provides the apparatus of example 1, in which the message indicates a modification of a value of the first variable by the first neuron, and the second neuron is to determine whether to modify its state by computing a change of cost based on the modification of the value of the first variable by the first neuron.

Example 3 provides the apparatus of example 1 or 2, in which the second neuron is to determine whether to modify its state further based on a weight, the weight corresponding to a synapse between the first neuron and the second neuron.

Example 4 provides the apparatus of example 3, in which the first neuron is to modify its state based on the weight and a message from the second neuron, the message from the second neuron indicating a modification of a value of the second variable by the second neuron.

Example 5 provides the apparatus of example 3 or 4, further including a fourth neuron including a fourth memory, the fourth memory to store a fourth variable, the fourth neuron to modify its state by modifying a value of the fourth variable based on the message from the first neuron and another weight corresponding to a synapse between the first neuron and the fourth neuron.

Example 6 provides the apparatus of any one of examples 1-5, in which the second neuron is to determine whether to modify its state by computing a probability of modifying its state based on the message from the first neuron.

Example 7 provides the apparatus of any one of examples 1-6, in which the second neuron is to determine whether to modify its state by comparing a number in the message from the first neuron with one or more other numbers.

Example 8 provides the apparatus of any one of examples 1-7, in which the first neuron or the second neuron is to store the value of the first variable or the second variable as a desirable value based on a message from the third neuron.

Example 9 provides the apparatus of example 8, in which the third neuron is to generate and send out the message based on a determination that the cost reaches a target cost or that a time associated with computing the cost reaches a time limit.

Example 10 provides the apparatus of any one of examples 1-9, further including a fourth neuron communicatively coupled with the first neuron and the second neuron, the fourth neuron to determine a level of noise and to send a message to the first neuron or the second neuron for reducing the level of noise.

Example 11 provides a method, including determining, by a first neuron, a value of a first variable by performing a modification of a previously determined value of the first variable, the first variable corresponding to an internal state of the first neuron; transmitting, from the first neuron to a second neuron, a message indicating the modification of the previously determined value of the first variable; determining, by the second neuron, a value of a second variable based on the message, the second variable corresponding to an internal state of the first neuron; and performing, by a third neuron, a computation of an cost function for combinatorial optimization based on the internal state of the first neuron and the internal state of the second neuron.

Example 12 provides the method of example 11, in which determining the value of the second variable includes computing a change of cost based on the modification of the value of the first variable by the first neuron; and determining whether to modify a previously determined value of the second variable based on the change of cost.

Example 13 provides the method of example 11 or 12, in which determining the value of the second variable includes determining whether to modify a previously determined value of the second variable further based on the message and a weight, the weight corresponding to a synapse between the first neuron and the second neuron.

Example 14 provides the method of any one of examples 11-13, in which determining the value of the second variable includes determining whether to modify a previously determined value of the second variable further by computing a probability of modifying its state based on the message from the first neuron or by comparing a number in the message from the first neuron with one or more other numbers.

Example 15 provides the method of any one of examples 11-14, further including transmitting the message from the first neuron to a fourth neuron; and determining, by the fourth neuron based on the message, a value of another variable stored in a memory of the fourth neuron.

Example 16 provides the method of any one of examples 11-15, further including after the computation of the cost function, transmitting a message from the third neuron to the first neuron or the second neuron, the message causing the first neuron or the second neuron to store the value of the first variable or the second variable as a best value of the first variable or the second variable.

Example 17 provides the method of example 16, in which transmitting a message from the third neuron to the first neuron or the second neuron includes determining, by the third neuron, whether the cost reaches a target cost; and in response to determining the cost reaches a target cost, transmitting from the third neuron the message to the first neuron or the second neuron.

Example 18 provides one or more non-transitory computer-readable media storing instructions executable to perform operations, the operations including determining, by a first neuron, a value of a first variable by performing a modification of a previously determined value of the first variable, the first variable corresponding to an internal state of the first neuron; transmitting, from the first neuron to a second neuron, a message indicating the modification of the previously determined value of the first variable; determining, by the second neuron, a value of a second variable based on the message, the second variable corresponding to an internal state of the first neuron; and performing, by a third neuron, a computation of an cost function for combinatorial optimization based on the internal state of the first neuron and the internal state of the second neuron.

Example 19 provides the one or more non-transitory computer-readable media of example 18, in which determining the value of the second variable includes determining whether to modify a previously determined value of the second variable further based on the message and a weight, the weight corresponding to a synapse between the first neuron and the second neuron.

Example 20 provides the one or more non-transitory computer-readable media of example 18 or 19, in which the operations further include after the computation of the cost function, transmitting a message from the third neuron to the first neuron or the second neuron, the message causing the first neuron or the second neuron to store the value of the first variable or the second variable as a best value of the first variable or the second variable.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
a first neuron of a neural network, the first neuron comprising a first memory for storing a first variable, different values of the first variable corresponding to different states of the first neuron;
a second neuron of the neural network, the second neuron communicatively coupled to the first neuron and comprising a second memory for storing a second variable, different values of the second variable corresponding to different states of the second neuron, the second neuron to determine whether to modify its state based on a message from the first neuron; and
a third neuron of the neural network, the third neuron communicatively coupled to the first neuron and the second neuron for computing a cost, using a cost function, from data received from the first neuron and data received from the second neuron and comprising a third memory for storing the cost.

2. The apparatus of claim 1, wherein the message indicates a modification of a value of the first variable by the first neuron, and the second neuron is to determine whether to modify its state by computing a change of cost based on the modification of the value of the first variable by the first neuron.

3. The apparatus of claim 1, wherein the second neuron is to determine whether to modify its state further based on a weight, the weight corresponding to a synapse between the first neuron and the second neuron.

4. The apparatus of claim 3, wherein the first neuron is to modify its state based on the weight and a message from the second neuron, the message from the second neuron indicating a modification of a value of the second variable by the second neuron.

5. The apparatus of claim 3, further comprising:
a fourth neuron comprising a fourth memory, the fourth memory to store a fourth variable, the fourth neuron to modify its state by modifying a value of the fourth variable based on the message from the first neuron and another weight corresponding to a synapse between the first neuron and the fourth neuron.

6. The apparatus of claim 1, wherein the second neuron is to determine whether to modify its state by computing a probability of modifying its state based on the message from the first neuron.

7. The apparatus of claim 1, wherein the second neuron is to determine whether to modify its state by comparing a number in the message from the first neuron with one or more other numbers.

8. The apparatus of claim 1, wherein the first neuron or the second neuron is to store a value of the first variable or the second variable as a desirable value based on a message from the third neuron.

9. The apparatus of claim 8, wherein the third neuron is to generate and send out the message based on a determination that the cost reaches a target cost or that a time associated with computing the cost reaches a time limit.

10. The apparatus of claim 1, further comprising:
a fourth neuron communicatively coupled with the first neuron and the second neuron, the fourth neuron to:
receive a first message from the first neuron;
receive a second message from the second neuron; and
generate a single message from the first message and the second message.

11. A method, comprising:
determining, by a first neuron, a value of a first variable by performing a modification of a previously determined value of the first variable, the first variable corresponding to an internal state of the first neuron;
transmitting, from the first neuron to a second neuron, a message indicating the modification of the previously determined value of the first variable;
determining, by the second neuron, a value of a second variable based on the message, the second variable corresponding to an internal state of the first neuron; and
performing, by a third neuron, a computation of a cost function for combinatorial optimization based on the internal state of the first neuron and the internal state of the second neuron.

12. The method of claim 11, wherein determining the value of the second variable comprises:
computing a change of cost based on the modification of the value of the first variable by the first neuron; and
determining whether to modify a previously determined value of the second variable based on the change of cost.

13. The method of claim 11, wherein determining the value of the second variable comprises:
determining whether to modify a previously determined value of the second variable further based on a weight, the weight corresponding to a synapse between the first neuron and the second neuron.

14. The method of claim 11, wherein determining the value of the second variable comprises:
determining whether to modify a previously determined value of the second variable further by computing a probability of modifying its state based on the message from the first neuron or by comparing a number in the message from the first neuron with one or more other numbers.

15. The method of claim 11, further comprising:
transmitting the message from the first neuron to a fourth neuron; and
determining, by the fourth neuron based on the message, a value of another variable stored in a memory of the fourth neuron.

16. The method of claim 11, further comprising:
after the computation of the cost function, transmitting a message from the third neuron to the first neuron or the second neuron, the message causing the first neuron or the second neuron to store the value of the first variable or the second variable as a best value of the first variable or the second variable.

17. The method of claim 16, wherein transmitting a message from the third neuron to the first neuron or the second neuron comprises:
determining, by the third neuron, whether the cost reaches a target cost; and
in response to determining the cost reaches a target cost, transmitting from the third neuron the message to the first neuron or the second neuron.

18. One or more non-transitory computer-readable media storing instructions executable to perform operations, the operations comprising:
determining, by a first neuron, a value of a first variable by performing a modification of a previously determined value of the first variable, the first variable corresponding to an internal state of the first neuron;
transmitting, from the first neuron to a second neuron, a message indicating the modification of the previously determined value of the first variable;
determining, by the second neuron, a value of a second variable based on the message, the second variable corresponding to an internal state of the first neuron; and
performing, by a third neuron, a computation of a cost function for combinatorial optimization based on the internal state of the first neuron and the internal state of the second neuron.

19. The one or more non-transitory computer-readable media of claim 18, wherein determining the value of the second variable comprises:
determining whether to modify a previously determined value of the second variable further based on the message and a weight, the weight corresponding to a synapse between the first neuron and the second neuron.

20. The one or more non-transitory computer-readable media of claim 18, wherein the operations further comprise:
after the computation of the cost function, transmitting a message from the third neuron to the first neuron or the second neuron, the message causing the first neuron or the second neuron to store the value of the first variable or the second variable as a best value of the first variable or the second variable.
